(19) United States
(12) Patent Application Publication
(10) Pub. No.: US 2015/0324885 A1
(43) Pub. Date: Nov. 12, 2015

(54) Presenting Service Options Using a Model of a Vehicle

(71) Applicant: John Griffin, Layton, UT (US)

(72) Inventor: John Griffin, Layton, UT (US)

(21) Appl. No.: 14/272,388

(22) Filed: May 7, 2014

(51) Int. Cl. G06Q 30/06; G06Q 50/10

(52) U.S. Cl. CPC G06Q 30/0621; G06Q 30/0643; G06Q 50/10

(57) ABSTRACT

Service options that can be performed on a vehicle can be presented to the customer using a model of the vehicle. The model can be customized to include visual indications of the services that are recommended and then displayed to the customer so that the customer can quickly and easily identify which services are recommended. As a technician inspects a vehicle, he may use a first computing device, which displays available services for the vehicle, to input the services that are recommended for the vehicle. The customized model can then be generated using the recommended services and displayed on a second computing device to the customer. The customer can select services to be performed by interacting with the customized model. Then, these selections can be transmitted back to the first computing device for display to the technician to allow the technician to commence performing the selected services.

### CROSS-REFERENCE TO RELATED APPLICATIONS

Not Applicable.

### BACKGROUND

Many vehicle service centers provide services without requiring that the customer make an appointment. In order to meet customer expectations in such situations, it is important that the services be provided quickly. However, it can oftentimes be difficult to quickly identify services that may need to be performed on a vehicle.

For example, once a customer brings a vehicle in to a service center, the vehicle must be pulled into a service stall to allow a technician to inspect the condition and various systems and components of the vehicle. As the technician performs this inspection, he will typically write down a list of potential services that are recommended. The recommended services can be based on the condition of the vehicle as well as on the manufacturer's recommendations which may be independent of the condition of the vehicle.

After the inspection is performed and the list of potential services is compiled, the technician will typically pass the list to a manager that will discuss the potential services with the customer to allow the customer to select which services to have performed. Usually these potential services will be separated as either services recommended based on the condition of the vehicle or services recommended by the manufacturer. This list of potential services is oftentimes long and tedious for the customer to review. Finally, the manager will inform the technician of which services the customer selected to allow the technician to begin performing the services. The manager typically informs the technician using written or verbal communication which can oftentimes result in mistakes.

If this process of identifying recommended services and receiving the customer's selection of services to perform takes too long, the customer can become dissatisfied with the service center even if the selected services are ultimately performed in a satisfactory manner. In some cases, this dissatisfaction can cause the customer to bypass the inspection process in future visits and instead elect to have only a specific and predetermined service performed such as an oil change. This may result in various problems with the vehicle going undetected until more costly services or repairs are required, and also eliminates the service center's opportunity to perform additional services.

### BRIEF SUMMARY

The present invention extends to methods, systems, and computer program products for presenting service options that can be performed on a vehicle using a model of the vehicle. The model can be customized to include indications of the services that are recommended based on either or both the condition of the vehicle or manufacturer recommendations and then displayed to the customer so that the customer can quickly and easily identify which services are recommended. The present invention therefore facilitates presenting recommended services to the customer and receiving the customer's selection of recommended services in a quick and easy manner.

As a technician inspects a vehicle, he may use a first computing device, which displays the model for the vehicle, to input the services that are recommended for the vehicle thereby creating the customized model. The customized model can then be displayed on a second computing device to the customer. The customer can select services to be performed by interacting with the customized model being displayed on the second computing device. Then, these selections can be transmitted back to the first computing device for display to the technician to allow the technician to commence performing the selected services.

By employing separate computing devices to create the customized model and to receive the customer's selection of services, the identification of which services to perform, including receiving customer authorization to perform such services, can be performed in a quick and efficient manner. Further, the customized model can provide greater insight to the customer regarding the services that are recommended thereby increasing the customer's satisfaction with the process.

In one example embodiment, the present invention is implemented as a method for presenting a customized model of a vehicle to a customer to receive the customer's selection of one or more services to be performed on the vehicle. A customized model of a customer's vehicle is created. The customized model includes a plurality of parts of the customer's vehicle and a plurality of visual indicators. Each visual indicator is associated with a service that can be performed on a part of the vehicle. The customized model is displayed on a first computing device to the customer. A first visual indicator is displayed with a different visual appearance than at least one other visual indicator. The different visual appearance identifies that the service associated with the first visual indicator is recommended. Customer input is received that selects at least one of the visual indicators. The selection of a visual indicator comprises a request to have the associated service performed. An indication of the at least one selected visual indicator is transmitted to a second computing device to enable the second computing device to display the at least one selected service to a technician.

In another example embodiment, the present invention is implemented as a method for creating a customized model of a vehicle and displaying the customized model to a customer to allow the customer to select one or more services to be performed on the vehicle. A model of a customer's vehicle is displayed on a technician computing device. The model is displayed with a plurality of visual indicators, each visual indicator being associated with a service that the technician can perform on the vehicle. Each visual indicator is also displayed overtop or near a component or system of the vehicle on which the corresponding service is performed. Input is received from the technician that selects at least one of the visual indicators, the selection of a visual indicator comprising a recommendation that the service represented by the visual indicator be performed on the vehicle. A customized model of the vehicle is created. The customized model includes a visual indicator for each recommended service. The customized model is displayed on a customer computing device. Each visual indicator included in the customized model is displayed with a first appearance. Customer input is received at the customer computing device that selects one or more of the at least one visual indicator displayed with the customized model. In response to the customer input, the display of the one or more selected visual indicators is updated on the customer computing device such that each selected visual indicator has a second appearance. The display of the model on the technician computing device is also updated such that each visual indicator of the model that corresponds to a selected visual indicator of the customized model is displayed with an updated appearance, the updated appearance indicating that the customer has authorized the technician to perform the corresponding service.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing environment in which the present invention can be implemented;

FIG. 2 illustrates a flowchart for creating and presenting a customized model of a vehicle to a customer to allow the customer to select services to be performed;

FIG. 3 illustrates an example user interface that can be displayed to a technician for receiving input identifying which services the technician recommends be performed on a customer's vehicle;

FIG. 4A illustrates a first example model of a vehicle that includes a plurality of visual indicators representing services that can be performed on the vehicle;

FIG. 4B illustrates a second example model of a vehicle that includes a plurality of visual indicators representing services that can be performed on the vehicle;

FIG. 5A illustrates an example user interface that can be displayed to the customer to summarize the services that the customer has selected;

FIG. 5B illustrates a timer that can be displayed to a customer and/or a technician to represent an estimated amount of time for completing the selected services;

FIG. 6 illustrates a flowchart of an example method for presenting a customized model of a vehicle to a customer to receive the customer's selection of one or more services to be performed on the vehicle;

FIG. 7 illustrates a flowchart of an example method for creating a customized model of a vehicle and displaying the customized model to a customer to allow the customer to select one or more services to be performed on the vehicle; and

FIGS. 8A-8M each represent an example user interface that can be displayed in accordance with one or more embodiments of the invention.

### DETAILED DESCRIPTION

The present invention extends to methods, systems, and computer program products for presenting service options that can be performed on a vehicle using a model of the vehicle. The model can be customized to include indications of the services that are recommended based on either or both the condition of the vehicle or manufacturer recommendations and then displayed to the customer so that the customer can quickly and easily identify which services are recommended. The present invention therefore facilitates presenting recommended services to the customer and receiving the customer's selection of recommended services in a quick and easy manner.

As a technician inspects a vehicle, he may use a first computing device, which displays the model for the vehicle, to input the services that are recommended for the vehicle thereby creating the customized model. The customized model can then be displayed on a second computing device to the customer. The customer can select services to be performed by interacting with the customized model being displayed on the second computing device. Then, these selections can be transmitted back to the first computing device for display to the technician to allow the technician to commence performing the selected services.

By employing separate computing devices to create the customized model and to receive the customer's selection of services, the identification of which services to perform, including receiving customer authorization to perform such services, can be performed in a quick and efficient manner. Further, the customized model can provide greater insight to the customer regarding the services that are recommended thereby increasing the customer's satisfaction with the process.

In one example embodiment, the present invention is implemented as a method for presenting a customized model of a vehicle to a customer to receive the customer's selection of one or more services to be performed on the vehicle. A customized model of a customer's vehicle is created. The customized model includes a plurality of parts of the customer's vehicle and a plurality of visual indicators. Each visual indicator is associated with a service that can be performed on a part of the vehicle. The customized model is displayed on a first computing device to the customer. A first visual indicator is displayed with a different visual appearance than at least one other visual indicator. The different visual appearance identifies that the service associated with the first visual indicator is recommended. Customer input is received that selects at least one of the visual indicators. The selection of a visual indicator comprises a request to have the associated service performed. An indication of the at least one selected visual indicator is transmitted to a second computing device to enable the second computing device to display the at least one selected service to a technician.

In another example embodiment, the present invention is implemented as a method for creating a customized model of a vehicle and displaying the customized model to a customer to allow the customer to select one or more services to be performed on the vehicle. A model of a customer's vehicle is displayed on a technician computing device. The model is displayed with a plurality of visual indicators, each visual indicator being associated with a service that the technician can perform on the vehicle. Each visual indicator is also displayed overtop or near a component or system of the vehicle on which the corresponding service is performed. Input is received from the technician that selects at least one of the visual indicators, the selection of a visual indicator comprising a recommendation that the service represented by the visual indicator be performed on the vehicle. A customized model of the vehicle is created. The customized model includes a visual indicator for each recommended service. The customized model is displayed on a customer computing device. Each visual indicator included in the customized model is displayed with a first appearance. Customer input is received at the customer computing device that selects one or more of the at least one visual indicator displayed with the customized model. In response to the customer input, the display of the one or more selected visual indicators is updated on the customer computing device such that each selected visual indicator has a second appearance. The display of the model on the technician computing device is also updated such that each visual indicator of the model that corresponds to a selected visual indicator of the customized model is displayed with an updated appearance, the updated appearance indicating that the customer has authorized the technician to perform the corresponding service.

Example Computing Architecture

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

Example Computing Environment

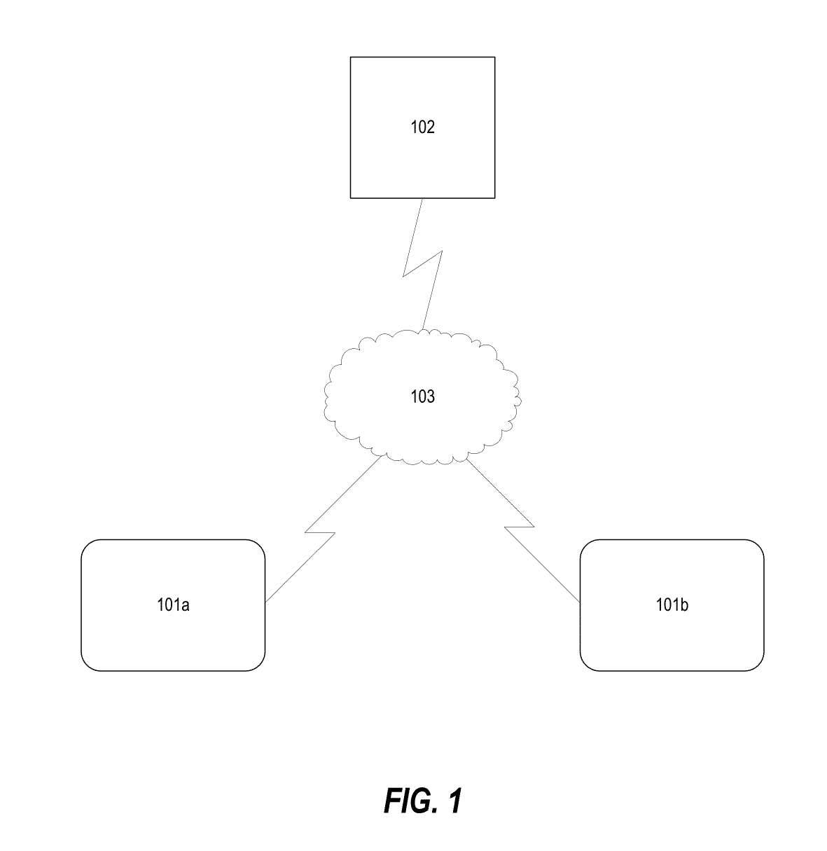

FIG. 1 illustrates an example computer environment 100 in which the present invention can be implemented. Computer environment 100 includes a first computing device 101a, a second computing device 101b, and a server 102 which are interconnected via a network 103.

In preferred embodiments, computing devices 101a and 101b can be mobile devices such as tablets or smart phones. The mobility of such devices can increase the efficiency of communicating between a technician and a customer as will be further described below. However, the present invention can equally be implemented where one or both devices 101a and 101b are less mobile or not mobile such as would be the case if the devices where laptops, desktop computers, or televisions. In essence, any device having a display can be used as first or second computing devices 101a and 101b.

Further, although FIG. 1 depicts only two computing devices 101a and 101b, the present invention can also be employed when more than two devices are used. For example, as will be apparent from the description below, multiple devices could be used to generate a customized model of a vehicle (e.g. when multiple technicians inspect the vehicle). Similarly, multiple devices could be used to view the customized model and select services (e.g. when there are two or more customers, such as a husband and wife, for the same vehicle). FIG. 1 is therefore intended only as a representation of a typical implementation of the present invention.

Server 102 is not necessary to implement the present invention but may be used to supply additional information that may be useful to the technician or customer. For example, server 102 may store models of vehicles which second computing device 101b accesses when a vehicle is brought to the service center. Server 102 may also store information (e.g. a manufacturer's recommendations) that can be presented to the technician to assist the technician in identifying which services to recommend. Server 102 may also store pricing information for services, customer information, or any other type of information that can be useful within a service center.

In some embodiments, one or more of computing devices 101a and 101b can be configured to store such additional information. In implementations where computing devices 101a and 101b are mobile devices, this information can be stored in a text format to minimize the storage requirement for such information. For example, one or more computing devices can store a service center's entire customer database as a collection of text files to allow the database to be maintained on a single tablet. This customer database may include information identifying each customer, vehicle information for each customer, service history for each customer, etc.

Network 103 can be any suitable network for communicating information between two or more computing systems. For example, network 103 can typically be a LAN within a service center. However, other types of networks may equally be employed such as peer-to-peer networks or even the internet. In one example implementation, computing device 101a may be configured to communicate directly with computing device 101b via a Bluetooth, WiFi, or other direct network connection.

Additionally, network 103 may encompass multiple different types of networks in some embodiments. For example, the present invention can be implemented as a mobile application that executes on each of computing devices 101a and 101b. In such cases, the mobile application on one device can communicate with the mobile application on another device in an appropriate manner based on how each device is connected to a network. If one device is the customer's mobile phone, this communication can be carried out via the customer's cellular provider's network. Alternatively, the devices may communicate via an access point to which both are connected. Accordingly, the present invention can be implemented using a variety of network architectures and configurations.

Presenting Service Options to a Customer Using a Model of a Vehicle

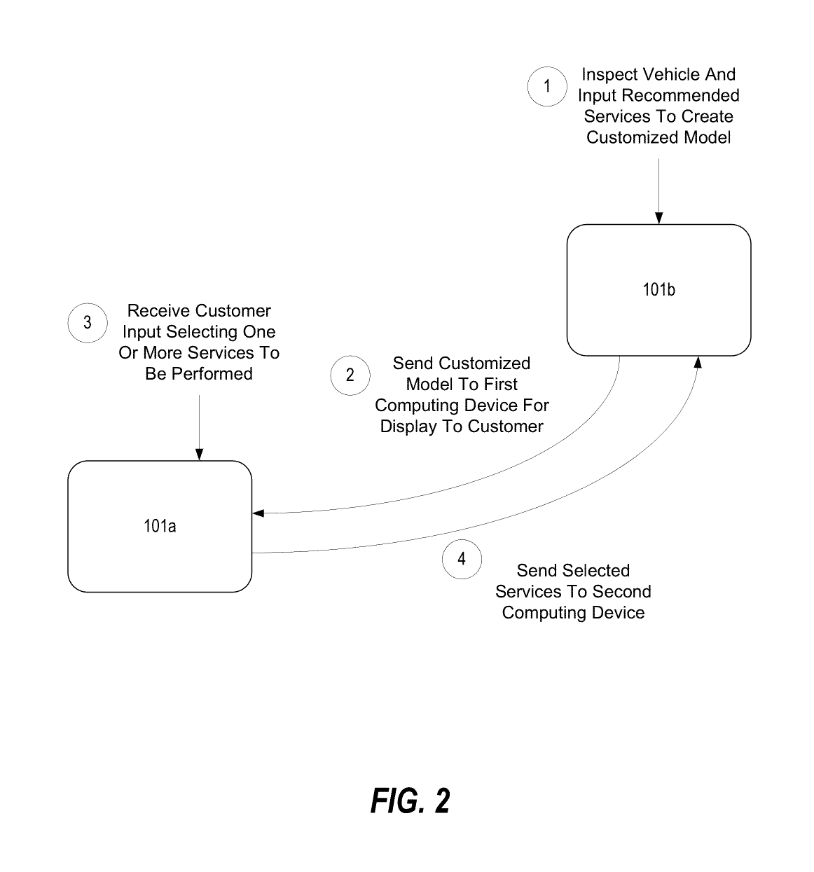

FIG. 2 illustrates a flowchart for creating and presenting a customized model of a vehicle to a customer to allow the customer to select services to be performed. In FIG. 2, computing device 101b represents the computing device that the technician uses to create a customized model of a vehicle while computing device 101a represents the computing device that the customer uses to view the customized model and select services.

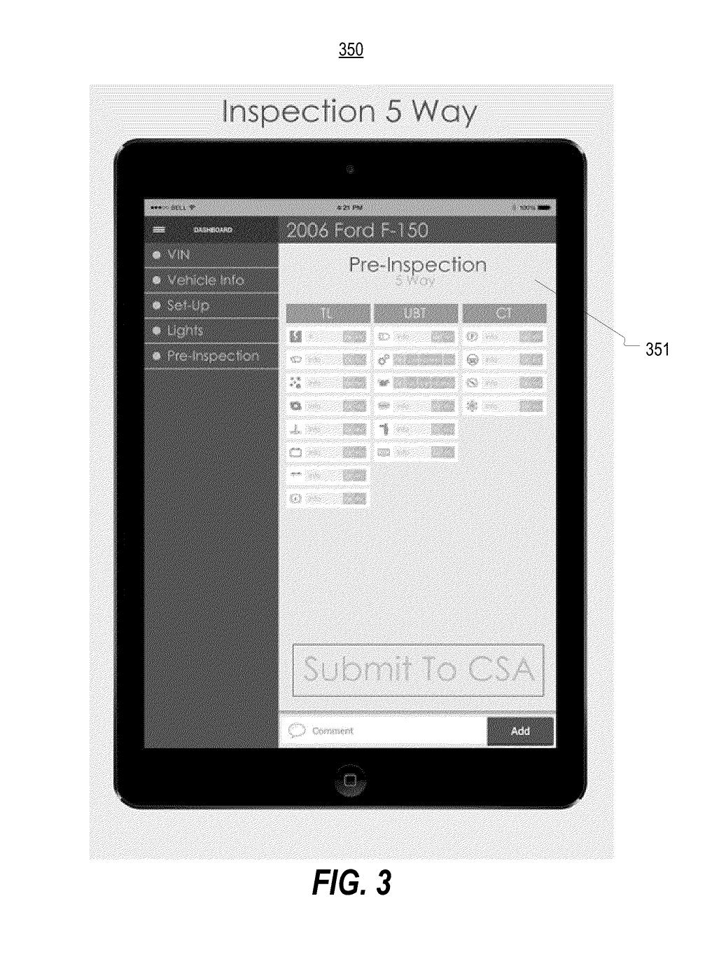

As shown, at a first step, the technician inspects a customer's vehicle. Various types of user interfaces can be employed on computing device 101b to assist the technician to input recommended services for the customer's vehicle. FIG. 3 provides an example of a user interface 350 that can be displayed to the technician. As shown in FIG. 3, user interface 350 can include a portion 351 in which various possible services for the customer's vehicle are listed. The technician, while or after inspecting the vehicle, can provide input to portion 351 to identify which of the possible services are recommended for the customer's vehicle. The identification of recommended services can be based on the visible inspection, on a manufacturer's recommendations, or both.

As indicated by the second step in FIG. 2, while or after the technician identifies the services that are recommended for the customer's vehicle, a customized model of the customer's vehicle can be created and displayed on computing device 101a. The customized model can be created on computing device 101b and then sent to computing device 101a for display, or information necessary for creating the customized model can be sent to computing device 101a which can then use the information to create and display the customized model. In any case, a customized model of the customer's vehicle is displayed on computing device 101a to allow the customer to view which services are recommended.

By creating a customized model in this manner, the recommended services can be presented to the customer very quickly. For example, using this process, the technician does not need to communicate the recommended services to any individual. Instead, the technician can input each recommended service while inspecting the vehicle (e.g. by carrying a tablet or smart phone during the inspection and selecting the services to recommend). These recommended services can be immediately routed to the computing device at the front desk or other location of the customer where they can be displayed in the form of a customized model which the customer can quickly and easily interpret.

The customized model can comprise a visual depiction of the customer's vehicle (e.g. a 3D model, drawing, or photograph) that includes a visual indicator for some or all of the possible services that can be performed on the customer's vehicle. In some embodiments of the invention, the visual indicator can comprise a separate element that is displayed overtop, near, or otherwise connected to a specific component, part, or system (hereinafter “part”) of the depicted vehicle on which the corresponding service can be performed. For example, if the recommended service is a transmission service, a user interface element can be displayed overtop or near the transmission in the model.

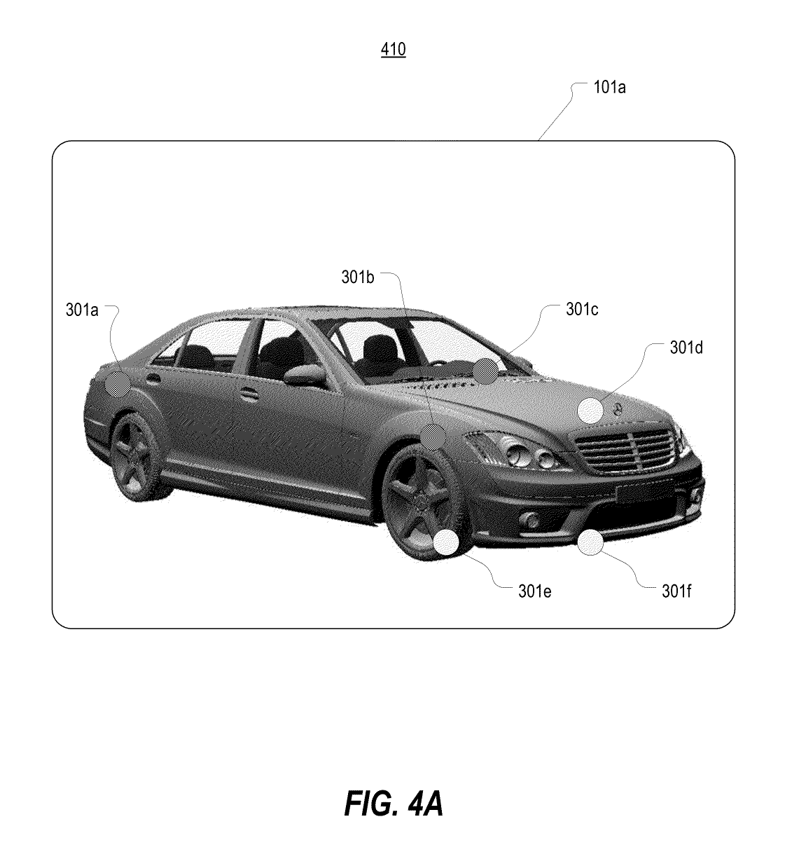

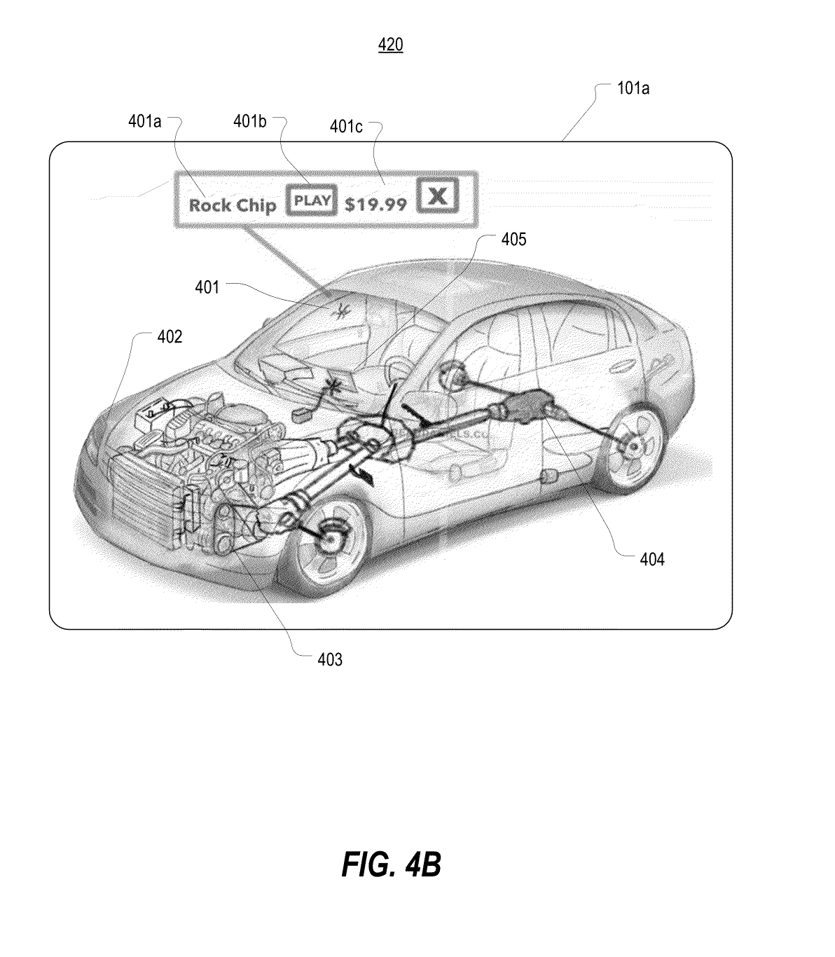

FIG. 4A provides one example of how such visual indicators can be displayed. In FIG. 4A, a model 410 is displayed with six visual indicators 301a-301f that are positioned overtop or near a part of the vehicle. These six visual indicators can represent six services that can be performed on the vehicle such as, for example, a fuel system service (indicator 301a), a suspension service (301b), a windshield wiper replacement service (301c), an engine service (301d), a tire rotation service (301e), and an oil change service (3010. Of course, any other number or type of service provided by the service center can be represented using a visual indicator.

Visual indicators 301a-301c are displayed with a different pattern than visual indicators 301d-301f. This different pattern represents that services are recommended for the parts associated with visual indicators 301a-301c. The pattern used in FIG. 3 can represent any of a number of different visual characteristics that may be employed to distinguish recommended services from non-recommended services. For example, visual indicators 301a-301c could be displayed with a red color while visual indicators 301d-301f could be displayed with a green color. Alternatively, each visual indicator could be given the same color while a different intensity or flashing could be used on visual indicators 301a-301c to distinguish the recommended services.

In other embodiments, the visual indicator can be in the form of a distinguishable visual appearance of the part on which the service is performed. In other words, a part that can be serviced can be given a different visual appearance in the model than a part on which services are not performed. For example, FIG. 4B illustrates a model 420 that has the appearance of an x-ray of the vehicle such that the vehicle's internal parts are visible. In such embodiments, parts for which a service can be performed may be given a distinct color based on whether the corresponding service is recommended or not. For example, any part for which a service is available but not recommended may be caused to have a green glowing appearance. Similarly, any part for which a service is recommended may be caused to have a red glowing appearance. In some embodiments, this glowing appearance may flash or otherwise emphasized. By changing the appearance of the part in the model, the customer can be quickly informed of the part or parts to which a particular service applies.

Model 420 in FIG. 4B includes five parts 401-405 whose appearance has been distinguished from the remaining parts of the vehicle. In this figure, parts 404 and 405 have a first appearance (e.g. a glowing green color) indicating that services corresponding to these parts are not recommended, while parts 401-403 have a second appearance (e.g. a glowing red color) indicating that services corresponding to these parts are recommended. The second appearance can be readily distinguishable from the first appearance so that the customer can quickly identify which services are recommended. The presence of the visual indicators in the customized model can assist the customer to quickly identify each service that has been recommended. In some embodiments, the location of the visual indicator can be sufficient to indicate the recommended service (e.g. if the visual indicator is over a wheel or a glowing wheel and the service center only performs tire rotations). However, in some embodiments, additional information can be provided in conjunction with the visual indicator to indicate the exact nature of the recommended service. For example, text describing the recommended service can be displayed on or near the visual indicator either continuously or in response to some input (e.g. by clicking on or hovering over the visual indicator). Alternatively, each visual indicator may be displayed with an identifier (e.g. a number), and a list of service descriptions associated with the appropriate identifier may be provided next to the model.

FIG. 4B provides an example of how additional information can be displayed when a customer selects a visual indicator. As shown, additional information 401a-401c is displayed regarding the service that is recommended for part 401 which, in this example, is a chipped windshield. This additional information includes an indication 401a of the part to be serviced or of the service to be performed, a component 401b that can be selected to play a video and/or audio clip describing the part and/or service to be performed on the part, and a price 401c for performing the recommended service. This additional information can be displayed in response to user input that selects a visual indicator in the model (e.g. when the user taps on the chip in the windshield). Similar additional information can be displayed when the customer selects a visual indicator shown in other types of models such as one shown in model 410 of FIG. 4A.

In some embodiments, when the user selects a visual indicator, the model can be zoomed in to focus on the part associated with the selected visual indicator. For example, with reference to FIG. 4B, when the user selects the chip in the windshield, the model can be zoomed in to focus on the chip and the additional information (401a-401c) can be displayed.

As indicated by the third step in FIG. 2, the visual indicators (or the additional information displayed when a visual indicator is selected) can be configured as or include selectable user interface elements so that the user can select to have a service performed by simply selecting the corresponding user interface element. For example, if the visual indicator is a button, the customer can select to have the corresponding service performed by selecting the button. In some embodiments, the visual indicators can be configured to change appearance once selected so that the customer can easily identify which services have been selected. For example, visual indicators may change in color, shape, pattern, size, intensity, or another characteristic when the corresponding service is selected so that the customer may distinguish selected services from unselected services. Other means for selecting a service can alternatively be provided. For example, a list of radio buttons corresponding to the recommended services can be provided next to the model.

Finally, as indicated by the fourth step in FIG. 2, the selected services can be sent back to computing device 101b to inform the technician of which services to perform on the vehicle. As can be seen, this process can be performed in a quick and efficient manner to ensure that the customer's vehicle can be serviced in the shortest amount of time possible. In a typical scenario, recommended services can be identified by the technician with only a few clicks on the display of computing device 101b (e.g. via user interface 350), and then services can be selected by the customer with only a few clicks on the display of computing device 101a (e.g. via model 410 or 420).

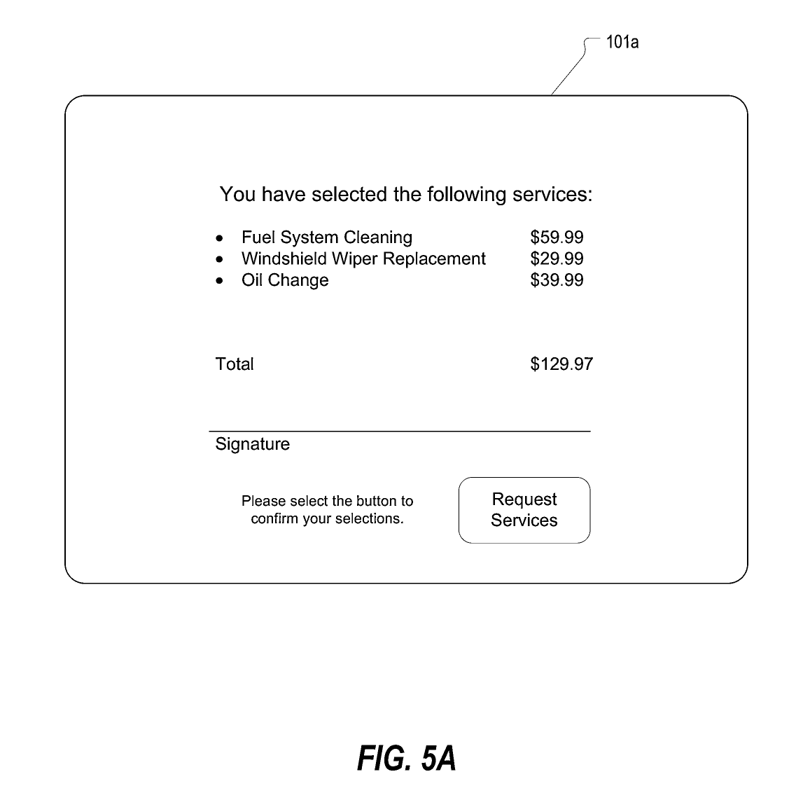

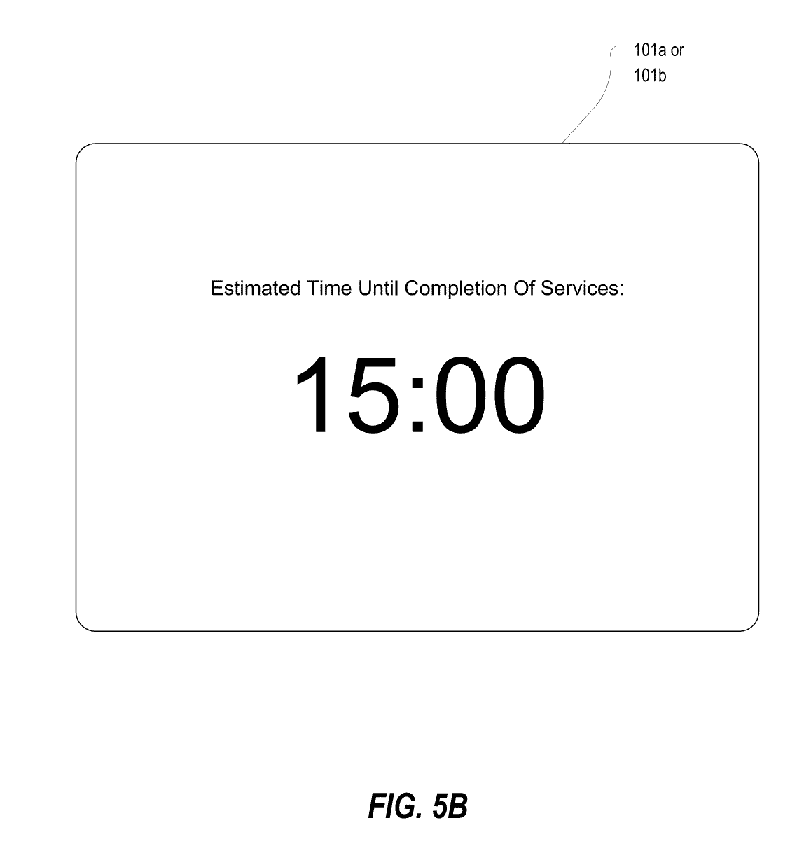

In some embodiments, after the customer has selected the services he desires to have performed, computing device 101a can display a summary of the services along with their cost. FIG. 5A provides an example of a summary screen that can be displayed when the customer has selected three services. This summary screen can include a signature line and/or a confirmation button that the customer can select to confirm his selection of the services to be performed. The summary screen may also display a total cost to have the selected services performed and/or an estimated time for performing the services. In such cases, once the customer selects the confirmation button, the selected services can be routed back to computing device 101b to inform the technician to begin performing the selected services.

In some embodiments, after the customer has selected the services to be performed, an estimated time for completing the services (which may be the same as an estimated time displayed on a summary screen) can be displayed on one or both of computing devices 101a and 101b. FIG. 5B provides an example of how this estimated time can be displayed. As shown, a timer can be generated based on which services were selected and can commence counting down once the selected services are requested or started.

When the timer is displayed on computing device 101b, the timer can serve as a reminder for the technician to complete the services within the estimated time presented to the customer. Also, if the timer is displayed on computing device 101a (or possibly another computing device accessible to the customer), the timer can inform the customer how much longer he will likely have to wait for the services to be performed. Knowing this estimated time can enhance the customer's experience and satisfaction by minimizing the restlessness the customer may otherwise feel when not knowing how long it may take to perform the services.

Although the above description states that a model of the customer's vehicle is displayed only on computing device 101a, in some embodiments of the invention, the same or a similar model of a customer's vehicle can be displayed on computing device 101b to assist the technician in identifying which services to recommend (i.e. prior to the model being presented to the customer) and/or in identifying which services should be performed (i.e. after the model has been presented to the customer and the customer has selected the services).

In such embodiment, the model of the vehicle may initially be displayed to the technician with all parts having the same visual indicator (e.g. all parts having a green visual indicator). Then, as or after the technician inspects the vehicle, the technician can select the visual indicators of parts for which services are recommended. The selection of a visual indicator by the technician may cause the visual indicator to be changed to a different appearance (e.g. from green to red). In this way, both the technician and the customer can interact with the model in a similar way. Also, in such embodiments, once the customer has selected which services to have performed, the model displayed on computing device 101b can be updated to distinguish the selected services (e.g. by changing the appearance of any visual indicator that was selected).

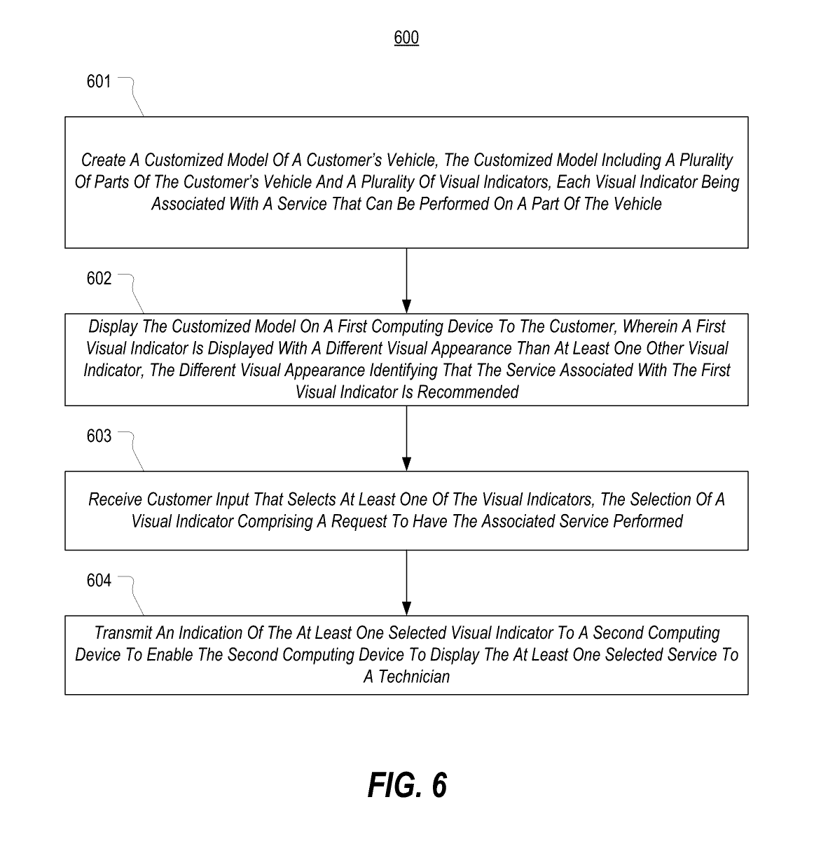

FIG. 6 illustrates a flowchart of an example method 600 for presenting a customized model of a vehicle to a customer to receive the customer's selection of one or more services to be performed on the vehicle.

Method 600 includes an act 601 of creating a customized model of a customer's vehicle, the customized model including a plurality of parts of the customer's vehicle and a plurality of visual indicators, each visual indicator being associated with a service that can be performed on a part of the vehicle. For example, model 410 or 420 can be generated.

Method 600 includes an act 602 of displaying the customized model on a first computing device to the customer, wherein a first visual indicator is displayed with a different visual appearance than at least one other visual indicator, the different visual appearance identifying that the service associated with the first visual indicator is recommended. For example, model 410 or 420 can be displayed on computing device 101a.

Method 600 includes an act 603 of receiving customer input that selects at least one of the visual indicators, the selection of a visual indicator comprising a request to have the associated service performed. For example, a customer can select one or more of visual indicators 301a-301f or 401-405 in models 410 or 420 respectively.

Method 600 includes an act 604 of transmitting an indication of the at least one selected visual indicator to a second computing device to enable the second computing device to display the at least one selected service to a technician. For example, an indication of a selected visual indicator can be transmitted to computing device 101b to allow the requested service to be displayed to the technician.

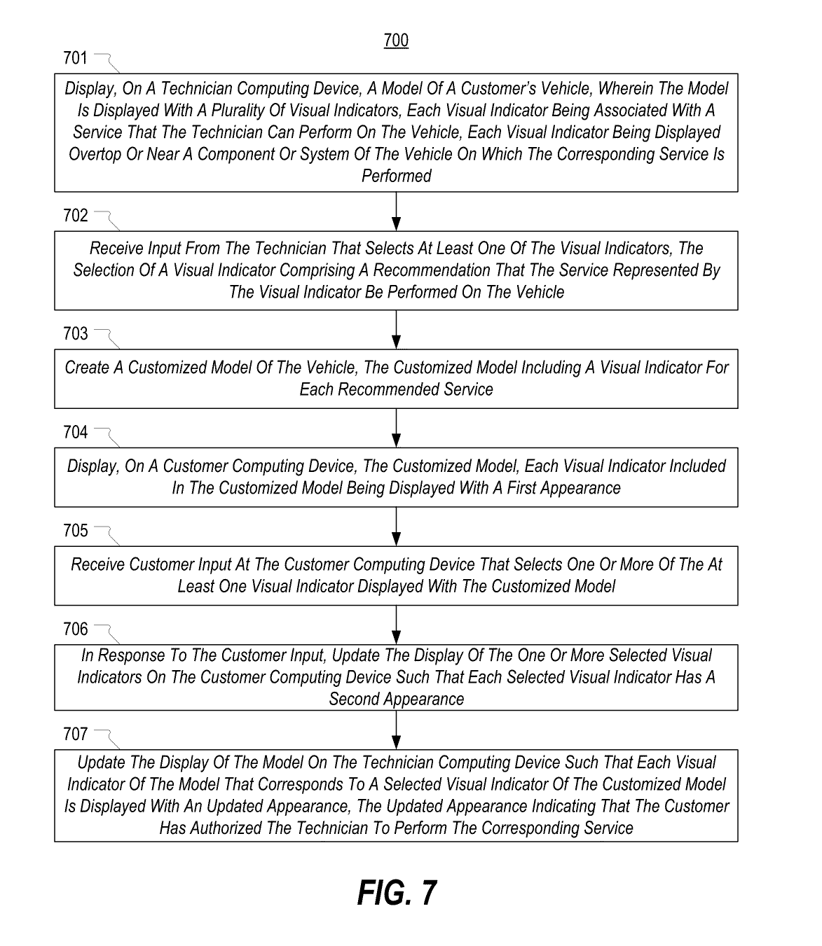

FIG. 7 illustrates a flowchart of an example method 700 for creating a customized model of a vehicle and displaying the customized model to a customer to allow the customer to select one or more services to be performed on the vehicle.

Method 700 includes an act 701 of displaying, on a technician computing device, a model of a customer's vehicle. The model is displayed with a plurality of visual indicators, each visual indicator being associated with a service that the technician can perform on the vehicle. Each visual indicator is also displayed overtop or near a component or system of the vehicle on which the corresponding service is performed. For example, the model shown in FIG. 3B can be displayed on computing device 101b with visual indicators 301a-301f.

Method 700 includes an act 702 of receiving input from the technician that selects at least one of the visual indicators, the selection of a visual indicator comprising a recommendation that the service represented by the visual indicator be performed on the vehicle. For example, computing device 101b can receive input from the technician that selects visual indicators 301a, 301c, and 301f.

Method 700 includes an act 703 of creating a customized model of the vehicle, the customized model including a visual indicator for each recommended service. For example, the customized model shown in FIG. 3D can be created.

Method 700 includes an act 704 of displaying, on a customer computing device, the customized model, each visual indicator included in the customized model being displayed with a first appearance. For example, the customized model shown in FIG. 3D can be displayed on computing device 101a.

Method 700 includes an act 705 of receiving customer input at the customer computing device that selects one or more of the at least one visual indicator displayed with the customized model. For example, computing device 101a can receive customer input that selects visual indicator 301f.

Method 700 includes an act 706 of in response to the customer input, updating the display of the one or more selected visual indicators on the customer computing device such that each selected visual indicator has a second appearance. For example, the updated customized model shown in FIG. 3E can be displayed on computing device 101a.

Method 700 includes an act 707 of updating the display of the model on the technician computing device such that each visual indicator of the model that corresponds to a selected visual indicator of the customized model is displayed with an updated appearance, the updated appearance indicating that the customer has authorized the technician to perform the corresponding service. For example, the updated model shown in FIG. 3F can be displayed on computing device 101b.

Identifying Vehicle Using VIN

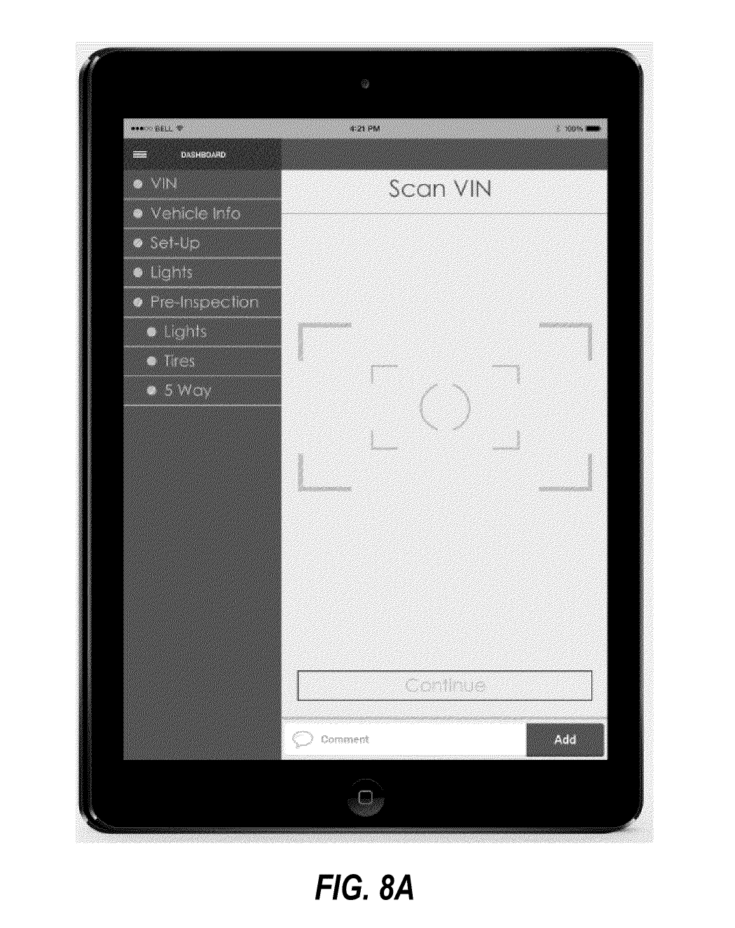

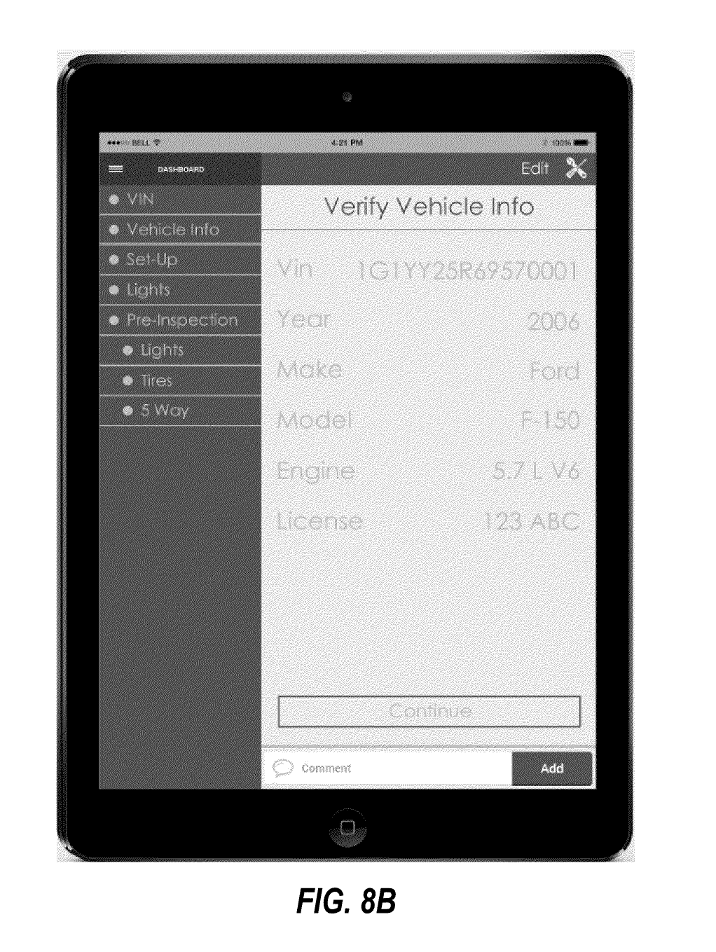

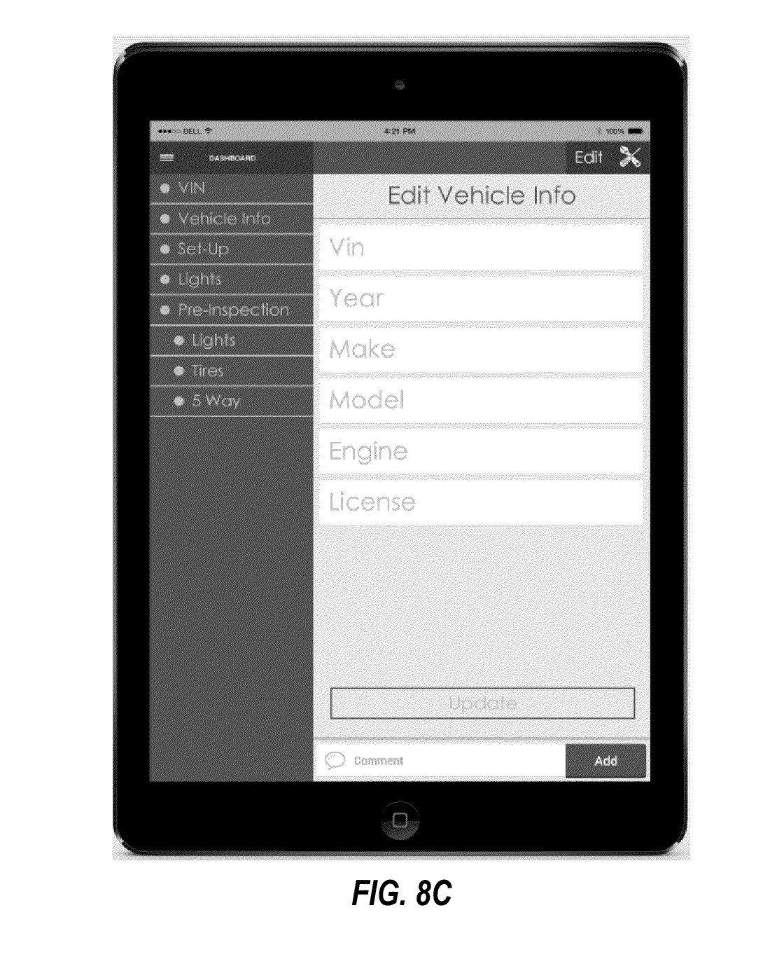

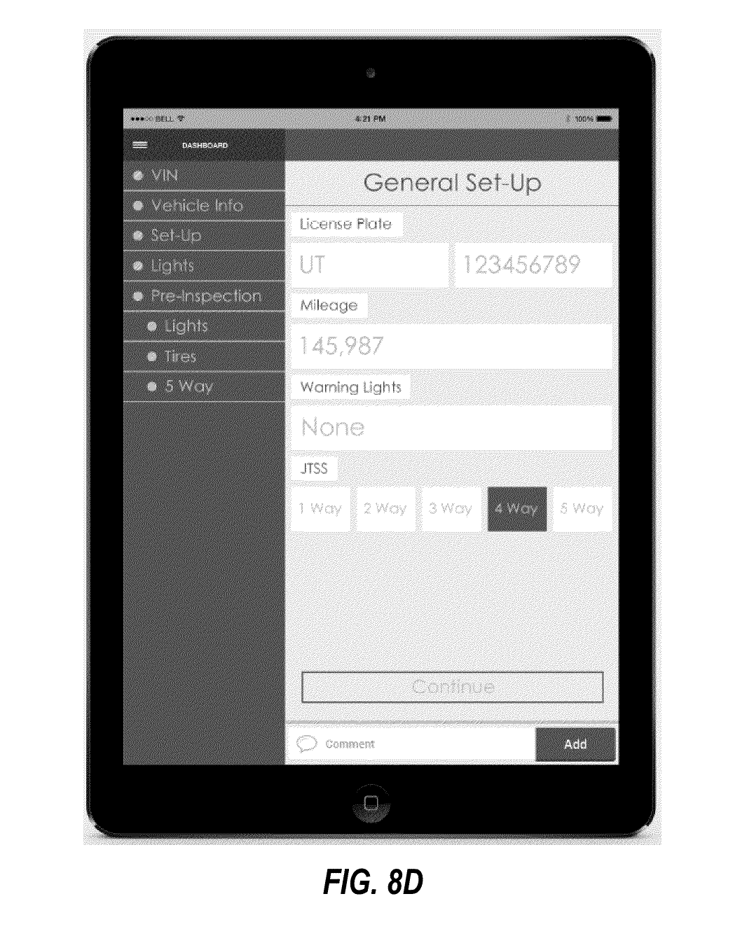

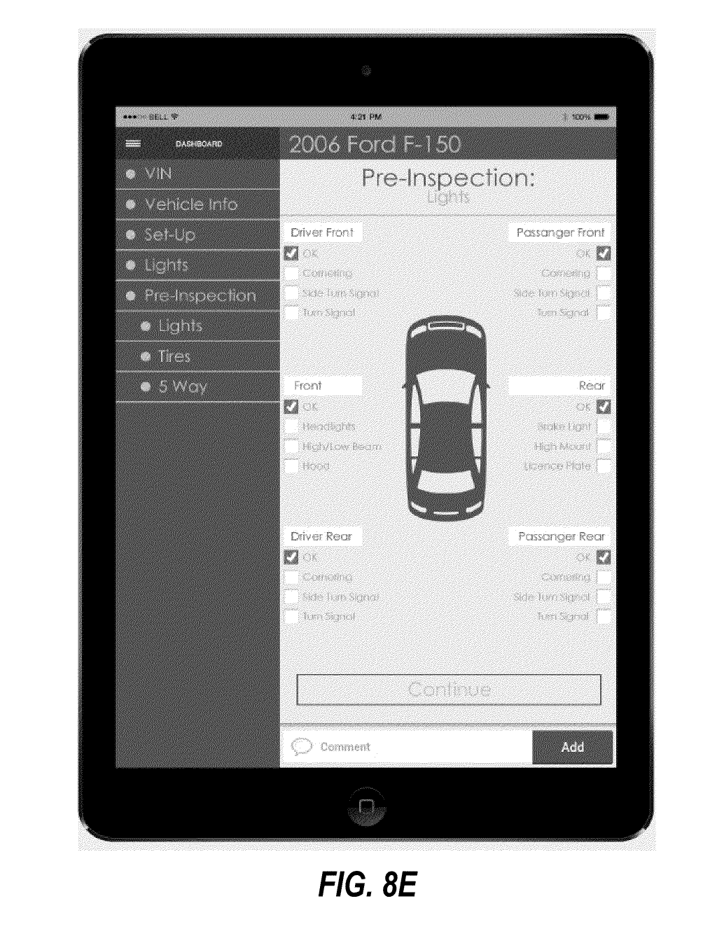

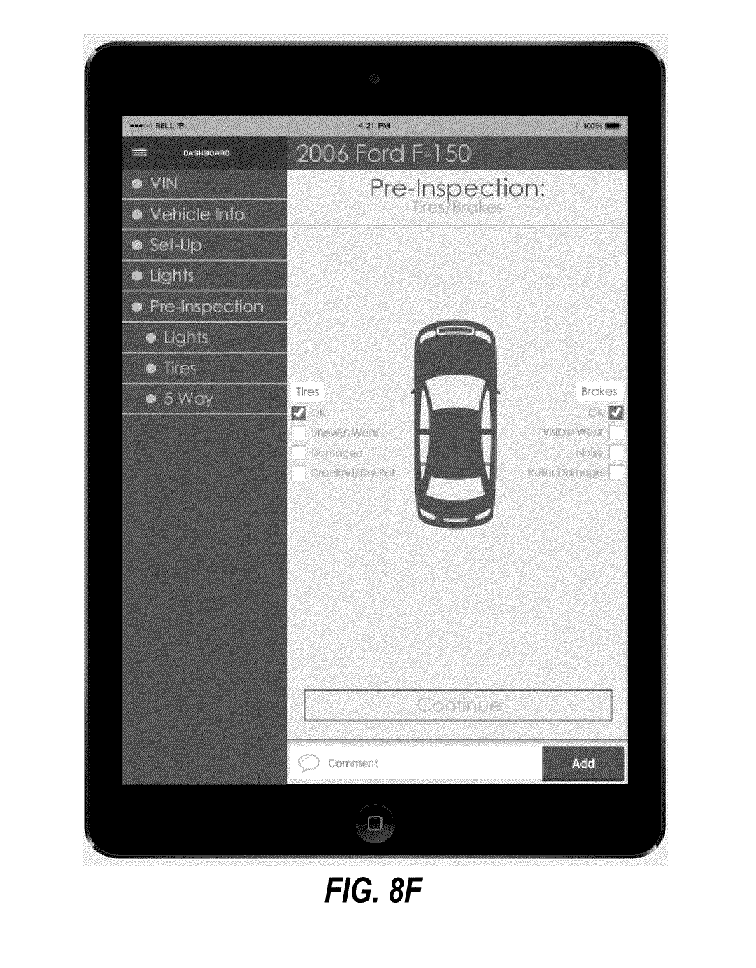

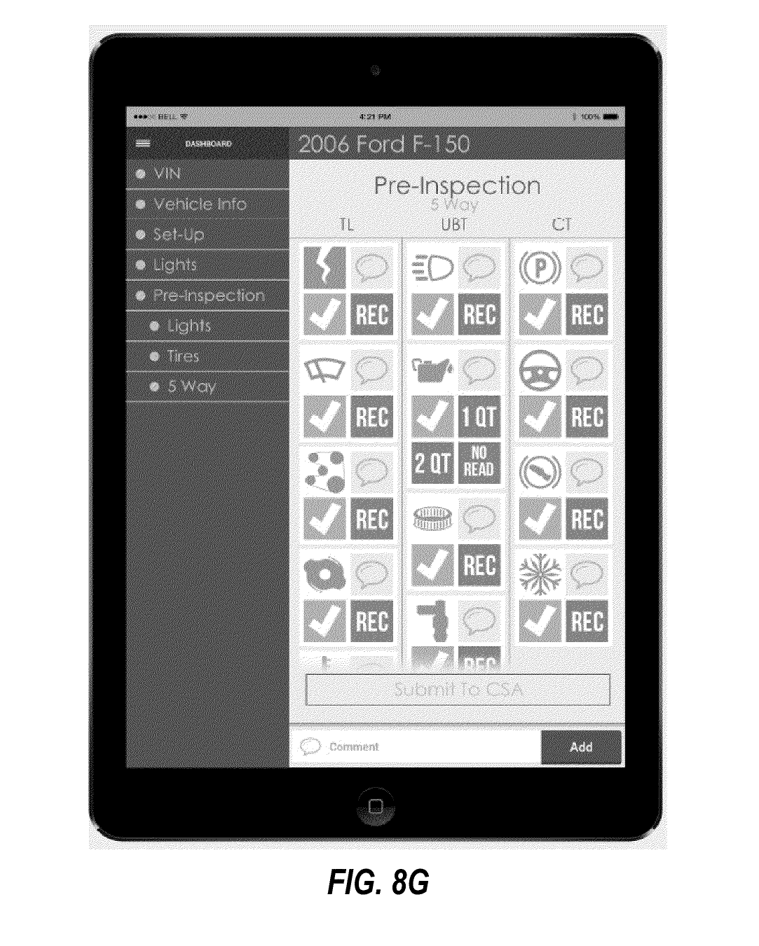

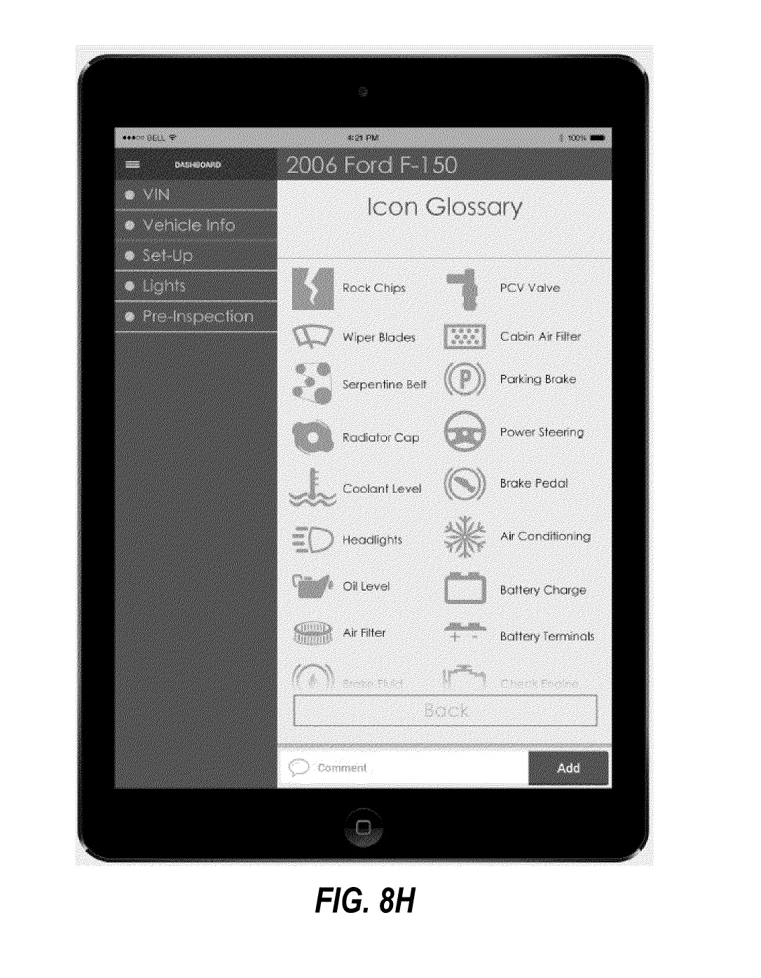

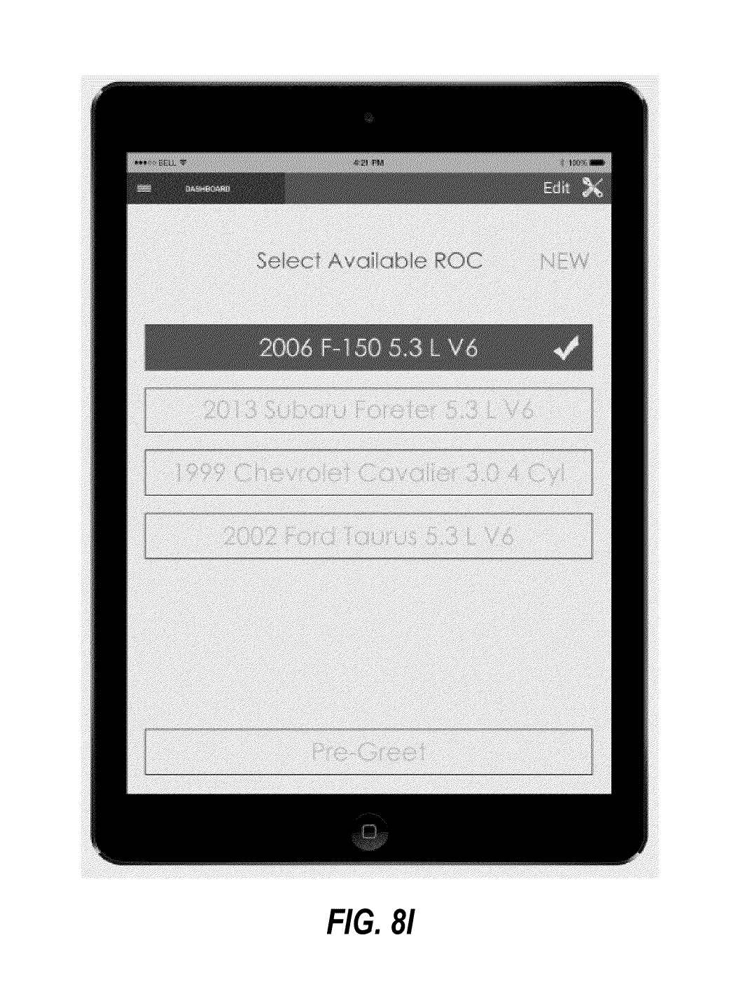

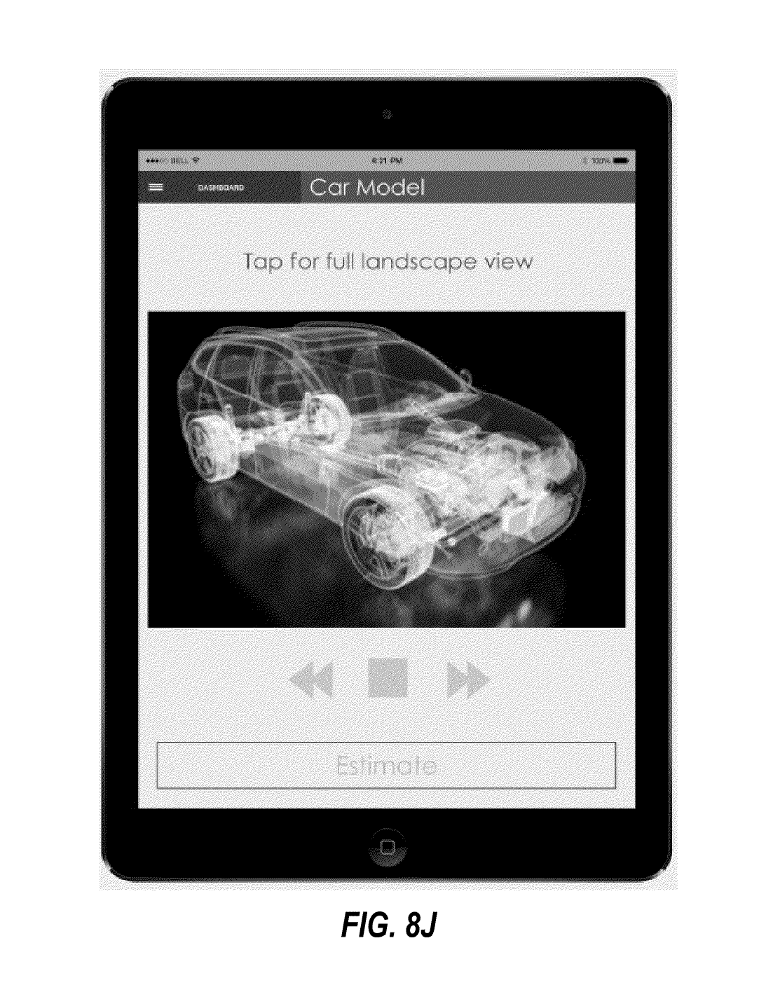

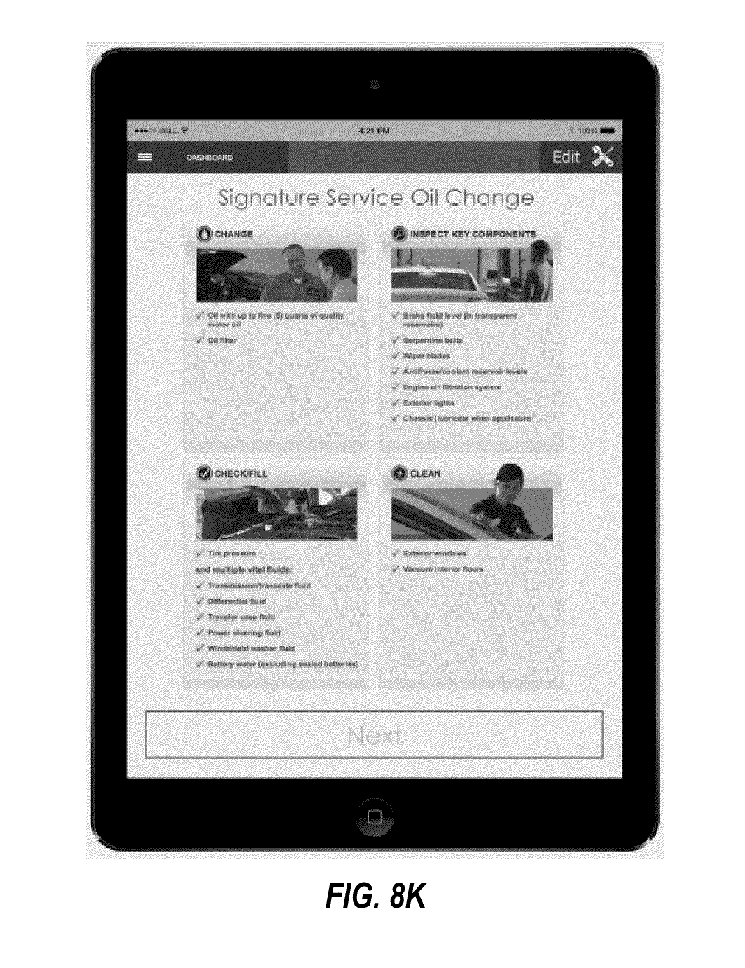

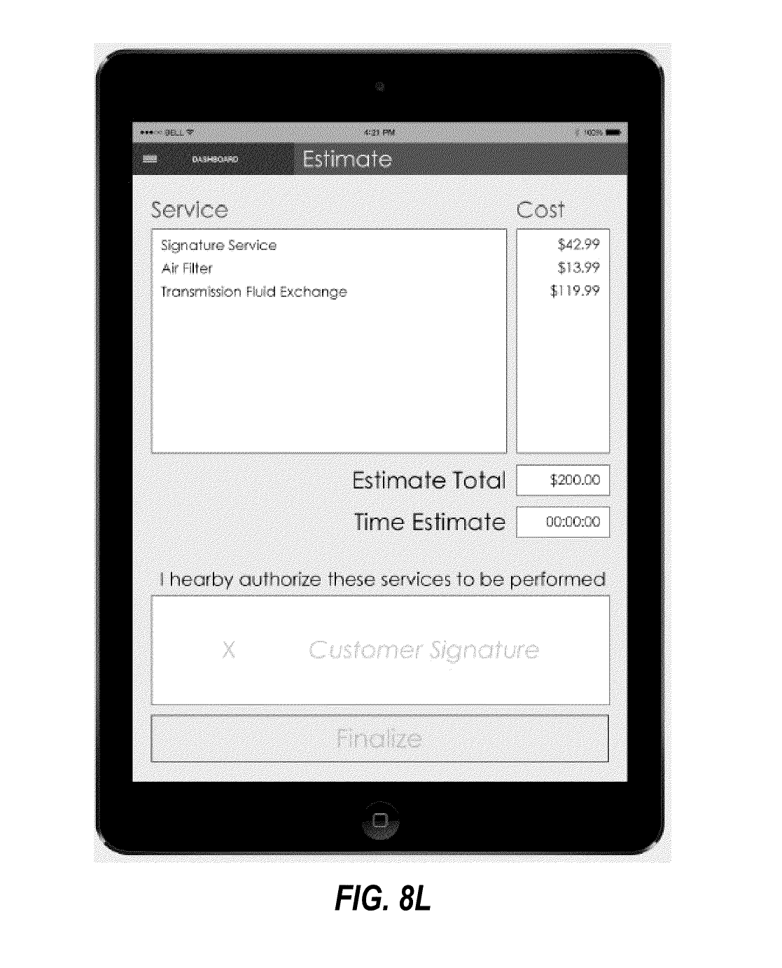

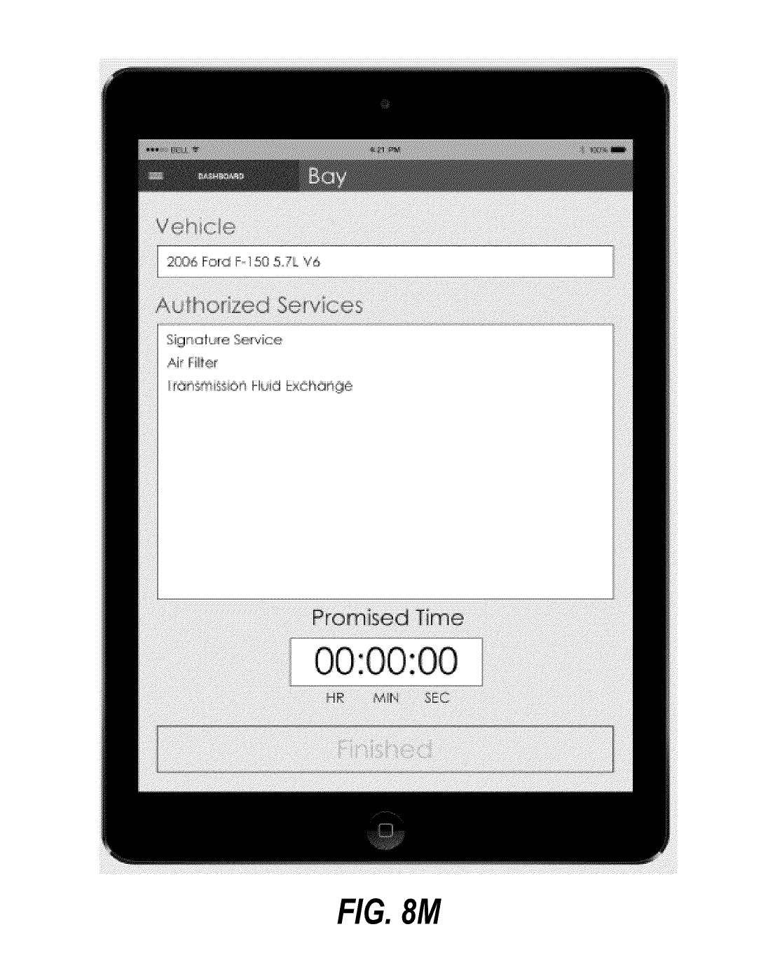

In some embodiments of the present invention, a vehicle identification number (VIN) scanner can be employed to automatically identify the type of vehicle. For example, upon a vehicle arriving at a service center, a technician can use a VIN scanner application on a computing device (e.g. on computing device 101b) to scan the vehicle's VIN. In some embodiments, the VIN scanner application can employ the computing device's camera to capture the VIN. A suitable user interface that can be displayed on the computing device to assist the technician in capturing the VIN is shown in FIG. 8A.

Once the vehicle's VIN has been captured, the VIN can be used to retrieve information about the vehicle including, for example, the vehicle's make, model, year, engine, license plate number, etc. This information may be retrieved from a local source (e.g. when the information has previously been obtained such as during a previous service or from the customer), or from a remote source (e.g. from vehicle registration databases, manufacturer databases, etc.). Any information retrieved using the VIN can be presented on the computing device to allow the technician to verify it such as is shown in FIG. 8B.

In some embodiments, the computing device can display a user interface to allow the technician to manually input information about the vehicle such as when some information may not be retrievable using the VIN or is incorrect. An example user interface for manually entering information is shown in FIG. 8C. Additionally, some information may require manual entry even when the VIN can be used to obtain information about the vehicle. For example, in many instances, the license plate number cannot be obtained using the VIN. Similarly, the mileage of the vehicle will be different at each visit and therefore requires manual entry. Also, any warning lights that may be activated on the vehicle's panel can be manually entered. An example user interface for inputting such information is shown in FIG. 8D.

In some embodiments, once information about the vehicle is obtained using the vehicle's VIN and possibly other manually input information (e.g. the license plate number), the information can be used to initiate the inspection of the customer's vehicle as is described above with respect to FIG. 2. For example, the VIN and/or the license plate number can be used to retrieve the vehicle's service history (e.g. when the vehicle has been previously serviced at the service center). The VIN can also be used to customize the user interface to include potential services that are applicable to the type of vehicle.

FIGS. 8E-8M provide additional example user interfaces that can be displayed to assist the technician and/or customer during the inspection and service selection process described with respect to FIG. 2. The user interfaces depicted in FIGS. 8E-8M can be used in place of or in addition to those shown in FIGS. 3, 4A, 4B, 5A, and 5B. Accordingly, each of the user interfaces shown in the figures is exemplary and should not limit the invention to any particular layout or content of the user interfaces.

FIGS. 8E-8H provide example user interfaces that can be displayed to a technician on a computing device (e.g. computing device 101b) to assist the technician in performing an inspection of the vehicle. FIG. 8E illustrates a user interface that can be used by the technician to input information regarding the lights of the vehicle. FIG. 8F illustrates a user interface that can be used by the technician to input information regarding the tires and brakes of the vehicle. FIG. 8G illustrates a user interface that can be used by the technician to input information regarding other components/systems of the vehicle. FIG. 8G includes a number of icons that each represents a different component/system. Each icon is also displayed with a check icon which can be selected to indicate that no service is recommended for the associated component/system, a recommend (“rec”) icon which can be selected to indicate that a service is recommended for the associated component/system, and a comment icon that can be selected to input comments about the associated component/system. FIG. 8H illustrates a user interface that provides a glossary of the icons displayed in the user interface of FIG. 8G.

Once the inspection of the vehicle has been completed, the recommended services can be presented to the customer as described above with respect to FIG. 2. FIGS. 8I-8L illustrate example user interfaces that can be displayed to the customer (e.g. using computing device 101a as described above). FIG. 8I illustrates an initial user interface that can be displayed to allow the technician and/or customer to select the appropriate vehicle (e.g. when multiple vehicles have been inspected and are ready to be reviewed). FIG. 8J illustrates a customized model of a vehicle where the components/systems for which services have been recommended are highlighted to assist the customer in quickly identifying which services have been recommended. FIG. 8K illustrates a user interface that can be displayed when a particular component/system has been selected. In this case, the selected component/system corresponds with an oil change recommendation, and therefore, the user interface displays information regarding the oil change service. FIG. 8L illustrates a checkout screen that lists the services that the customer has selected along with an estimated cost and time for performing the services. A signature area is also displayed to receive the customer's signature as authorization to perform the services.

As described above, after the customer has selected services and provided authorization, the technician can be notified. FIG. 8M illustrates an example user interface that can be displayed to the technician (e.g. on computing device 101b) to inform the technician of the services that the customer has selected. As shown, the user interface may include a time that represents the estimated time provided to the customer for completing the services. This estimated time may remain fixed (e.g. by indicating a future time when the services should be completed) or may count down (e.g. by indicating the amount of time remaining until the services should be completed).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A method for creating a customized model of a vehicle and displaying the customized model to a customer to allow the customer to select one or more services to be performed on the vehicle, the method comprising:
displaying, on a technician computing device, a plurality of services that can be performed on a customer's vehicle;
receiving input from the technician that selects at least one of the services, the selection of a service comprising a recommendation that the service be performed on the vehicle;
creating a customized model of the vehicle, the customized model including a visual indicator for each of the services;
displaying, on a customer computing device, the customized model, wherein a visual indicator for a recommended service is displayed with a different appearance than a visual indicator for a non-recommended service;
receiving customer input at the customer computing device that selects one or more of the visual indicators displayed with the customized model;
in response to the customer input, transmitting an indication of the one or more selected visual indicators to the technician computing device to enable the technician computing device to display a representation of each service associated with a selected visual indicator.

2. The method of claim 1, wherein the visual indicators comprise the appearance of parts of the vehicle in the customized model.

3. The method of claim 2, wherein parts associated with a recommended service are displayed with the different appearance.

4. The method of claim 2, wherein each part for which a visual indicator is displayed is selectable.

5. The method of claim 4, wherein, in response to the selection of a part, additional information is displayed regarding a service that can be performed on the part.

6. The method of claim 5, wherein the additional information includes one or more of:
a video of the part;
a description of the service that can be performed on the part;
a price for performing the service; or
an estimated time for performing the service.

7. The method of claim 1, further comprising:
displaying, on one or both of the technician and customer computing devices, a timer representing the estimated time for performing the one or more services associated with the one or more selected visual indicators.

8. A method for presenting a customized model of a vehicle to a customer to receive the customer's selection of one or more services to be performed on the vehicle, the method comprising:
creating a customized model of a customer's vehicle, the customized model including a plurality of parts of the customer's vehicle and a plurality of visual indicators, each visual indicator being associated with a service that can be performed on a part of the vehicle;
displaying the customized model on a first computing device to the customer, wherein a first visual indicator is displayed with a different visual appearance than at least one other visual indicator, the different visual appearance identifying that the service associated with the first visual indicator is recommended;
receiving customer input that selects at least one of the visual indicators, the selection of a visual indicator comprising a request to have the associated service performed; and
transmitting an indication of the at least one selected visual indicator to a second computing device to enable the second computing device to display the at least one selected service to a technician.

9. The method of claim 8, wherein creating a customized model of the customer's vehicle comprises:
receiving, by the second computing device, input from the technician identifying the one or more recommended services.

10. The method of claim 9, wherein the input from the technician comprises the selection of one or more visual indicators displayed in conjunction with a model of the vehicle.

11. The method of claim 8, wherein the model of the vehicle includes a visual indicator for each service that can be provided by the technician on the vehicle.

12. The method of claim 8, wherein the visual indicator comprises one of:
an appearance of a part on which the associated service is performed; or
an element that is displayed in association with a part on which the associated service is performed.

13. The method of claim 8, wherein the different visual appearance comprises a different color.

14. The method of claim 8, wherein displaying the at least one selected service to a technician comprises updating a model of the vehicle being displayed on the second computing device.

15. The method of claim 14, wherein updating the model of the vehicle being displayed on the second computing device comprises changing the appearance of at least one visual indicator displayed on the model that represents the at least one selected service.

16. The method of claim 8, further comprising:
scanning a VIN of the vehicle to obtain information about the vehicle;
wherein the customized model is created at least partially based on the information obtained by scanning the VIN.

17. The method of claim 8, further comprising:
displaying, on the first or second computing device, an estimated time to complete the at least one selected service.

18. The method of claim 8, further comprising:
in response to the customer input, displaying additional information about the associated service, the additional information including one or more of:
a description of a part on which the service is performed;
a description of how the service is performed on the part;
a video describing how the part functions or how the service is performed; or
a cost for performing the service.

19. A method for creating a customized model of a vehicle and displaying the customized model to a customer to allow the customer to select one or more services to be performed on the vehicle, the method comprising:
displaying, on a technician computing device, a model of a customer's vehicle, wherein the model is displayed with a plurality of visual indicators, each visual indicator being associated with a service that the technician can perform on the vehicle, each visual indicator being displayed overtop or near a component or system of the vehicle on which the corresponding service is performed;
receiving input from the technician that selects at least one of the visual indicators, the selection of a visual indicator comprising a recommendation that the service represented by the visual indicator be performed on the vehicle;
creating a customized model of the vehicle, the customized model including a visual indicator for each recommended service;
displaying, on a customer computing device, the customized model, each visual indicator included in the customized model being displayed with a first appearance;
receiving customer input at the customer computing device that selects one or more of the at least one visual indicator displayed with the customized model;
in response to the customer input, updating the display of the one or more selected visual indicators on the customer computing device such that each selected visual indicator has a second appearance; and
updating the display of the model on the technician computing device such that each visual indicator of the model that corresponds to a selected visual indicator of the customized model is displayed with an updated appearance, the updated appearance indicating that the customer has authorized the technician to perform the corresponding service.

20. The method of claim 19, further comprising:
displaying, on one or both of the technician and customer computing devices, a timer representing the estimated time for performing the one or more selected services.
